(19) United States
(12) Patent Application Publication
(10) Pub. No.: US 2020/0320609 A1
(43) Pub. Date: Oct. 8, 2020

(54) METHOD AND SYSTEM FOR PROVIDING PERSONALIZED RECOMMENDATIONS IN REAL-TIME

(71) Applicant: TOSHIBA TEC KABUSHIKI KAISHA, Tokyo (JP)

(72) Inventors: Abhishek RAJAPUROHIT, Bangalore (IN); Rahul Gupta, Bangalore (IN)

(73) Assignee: TOSHIBA TEC KABUSHIKI KAISHA, Tokyo (JP)

(21) Appl. No.: 16/516,537

(22) Filed: Jul. 19, 2019

(30) Foreign Application Priority Data
Apr. 8, 2019 (IN) 201941014100

(51) Int. Cl. G06Q 30/06

(52) U.S. Cl. CPC G06Q 30/0631; G06Q 30/0641

(57) ABSTRACT

The present subject matter is related in general to data analytics particularly disclosing a method and system for providing personalized recommendations in real-time. A recommendation generating system may receive input data related to an update by a user on the at least one social networking platform and may extract context related information from the input data. Subsequently, the recommendation generating system may identify actionable keywords from one or more keywords of context related information based on predefined actionable keywords. Further, profile data of the user and merchant data of one or more merchants may be retrieved in real-time. Furthermore, one or more merchants comprising at least one of products or services of interest for the user may be determined based on context related information, current location of user, merchant data and set of predefined rules and recommended to the user in real-time.

### CROSS-REFERENCE TO RELATED APPLICATION

This application is based upon and claims the benefit of priority from Indian Patent Application No. 2019-41014100, filed on Apr. 8, 2019, the entire contents of which are incorporated herein by reference.

### TECHNICAL FIELD

The present disclosure is generally related to data analytics and more particularly, but not exclusively, to a method and a system for providing personalized recommendations in real-time.

### BACKGROUND

The number of merchants providing products and services has increased substantially in recent years. Though e-commerce (i.e. buying and selling of products or services online) is convenient, many users still prefer to purchase products and services in physical stores. However, one concern is connecting a user demand with a merchant's supply as needs and demands of the user may vary based on situation or mood of the user. The existing techniques provide recommendations to the user only based on location of the user, which may not be appropriate for the needs and interests of the user. Some other existing techniques may correlate static profile information of the user retrieved from social networking platform with application services of merchants. Based on this correlation, the existing technique invokes services according to requirement of the user. However, this existing technique may not be applicable for recommendations based on real-time needs and interest of the user.

Further, in popular market areas, malls, shopping complexes, airports and the like, merchants situated on main roads or main aisles are most noticed and visited by the users due to visibility. Users may not be aware or may not explore other merchants who are not situated on the main road or main aisles. Due to low visibility of the merchants on the back aisles, the users may miss out on variety of products and services offered by these merchants, offers/discounts provided by the merchant, and the like. Instead, the user may purchase/use products and services of the merchants in the main road or main aisles, though the products and services are high priced and unsatisfactory. On the other hand, merchants may also lose users who may be interested in the products and services provided by the merchant due to low visibility.

Further, when users travel to new places on business trips, vacations and the like, users may want to explore the place, but may not know right places to visit, thus leading to scenarios such as visiting places that are very far from current location of the user or places that may not be of interest to him. Therefore, there is a need for connecting a user demand with a merchant's supply in real-time.

The information disclosed in this background section of the present disclosure is only for enhancement of understanding of the general background of the invention and should not be taken as an acknowledgement or any form of suggestion that this information forms the prior art already known to a person skilled in the art

### SUMMARY

One or more shortcomings of the prior art are overcome, and additional advantages are provided through the present disclosure. Additional features and advantages are realized through the techniques of the present disclosure. Other embodiments and aspects of the disclosure are described in detail herein and are considered a part of the claimed disclosure.

The present disclosure provides a method of providing personalized recommendations in real-time. The method includes receiving, by a recommendation generating system, input data from at least one social networking platform in real-time. The input data is related to an update by a user on the at least one social networking platform. Further, the method includes extracting context related information from the input data. The context related information comprises one or more keywords and at least one of situation of the user or hashtag related information. Subsequently, the method includes identifying actionable keywords from the one or more keywords based on predefined actionable keywords. Upon identifying the actionable keywords, the method includes retrieving profile data of the user and merchant data of one or more merchants in real-time, when the actionable keywords are identified. The profile data is retrieved from the at least one social networking platform and the merchant data is retrieved from a merchant database associated with the recommendation generating system. Further, the method includes determining one or more merchants comprising at least one of products or services of interest for the user based on the context related information, current location of the user, the merchant data and a set of predefined rules. Finally, the method includes recommending the one or more merchants to the user in real-time.

Further, the present disclosure comprises a recommendation generating system for providing personalized recommendations in real-time. The recommendation generating system comprises a processor and a memory communicatively coupled to the processor. The memory stores the processor-executable instructions, which, on execution, causes the processor to receive input data from at least one social networking platform in real-time. The input data is related to an update by a user on the at least one social networking platform. Further, the processor extracts context related information from the input data. The context related information comprises one or more keywords and at least one of situation of the user or hashtag related information. Subsequently, the processor identifies actionable keywords from the one or more keywords based on predefined actionable keywords. Upon identifying the actionable keywords, the processor retrieves profile data of the user and merchant data of one or more merchants in real-time, when the actionable keywords are identified. The profile data is retrieved from the at least one social networking platform and the merchant data is retrieved from a merchant database associated with the recommendation generating system. Further, the processor determines one or more merchants comprising at least one of products or services of interest for the user based on the context related information, current location of the user, the merchant data and a set of predefined rules. Finally, the processor recommends the one or more merchants to the user in real-time.

Furthermore, the present disclosure comprises a non-transitory computer readable medium including instructions stored thereon that when processed by at least one processor causes a recommendation generating system to receive input data from at least one social networking platform in real-time. The input data is related to an update by a user on the at least one social networking platform. Further, the instructions cause the processor to extract context related information from the input data. The context related information comprises one or more keywords and at least one of situation of the user or hashtag related information. Subsequently, the instructions cause the processor to identify actionable keywords from the one or more keywords based on predefined actionable keywords. Further, the instructions cause the processor to retrieve profile data of the user and merchant data of one or more merchants in real-time, when the actionable keywords are identified. The profile data is retrieved from the at least one social networking platform and the merchant data is retrieved from a merchant database associated with the recommendation generating system. Furthermore, the instructions cause the processor to determine one or more merchants comprising at least one of products or services of interest for the user based on the context related information, current location of the user, the merchant data and a set of predefined rules. Finally, the instructions cause the processor to recommend the one or more merchants to the user in real-time.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING DIAGRAMS

The accompanying drawings, which are incorporated in and constitute a part of the present disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

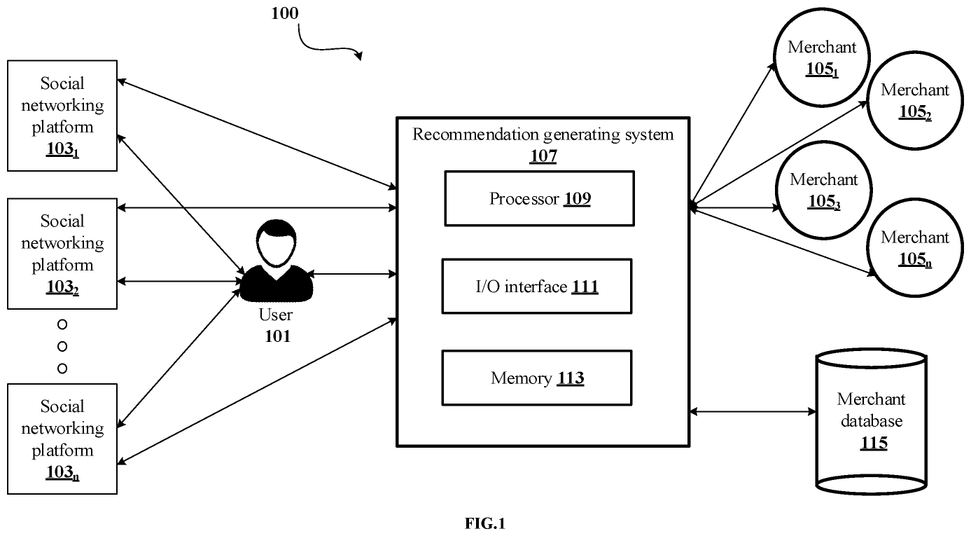

FIG. 1 shows an exemplary architecture for providing personalized recommendations in real-time in accordance with some embodiments of the present disclosure;

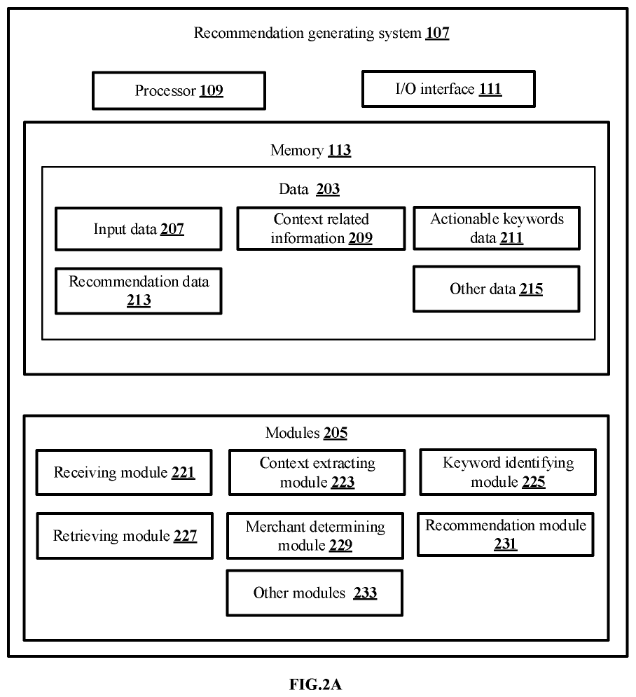

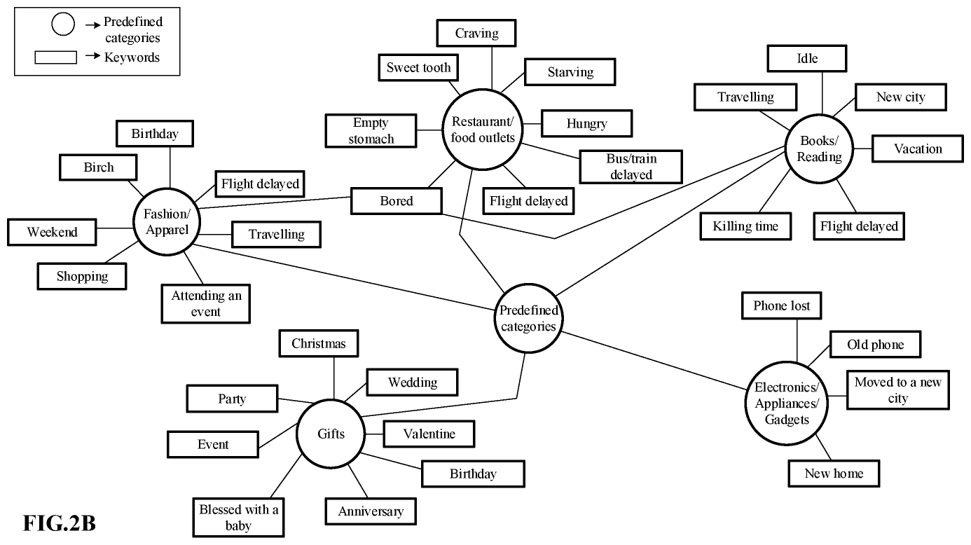

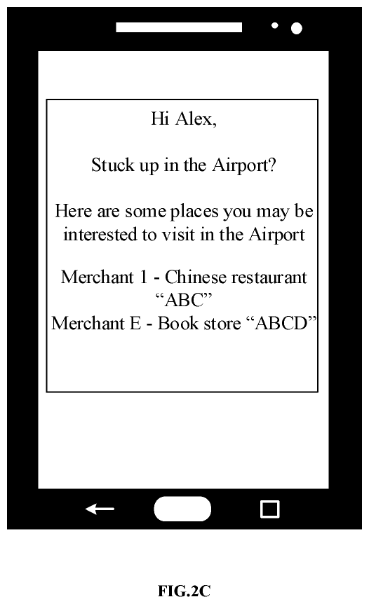

FIG. 2A shows a detailed block diagram of a recommendation generating system for providing personalized recommendations in real-time in accordance with some embodiments of the present disclosure;

FIG. 2B is a pictorial representation of exemplary predefined categories and corresponding exemplary actionable keywords in accordance with some embodiments of the present disclosure;

FIG. 2C shows an exemplary recommendation provided to the user in accordance with some embodiments of the present disclosure;

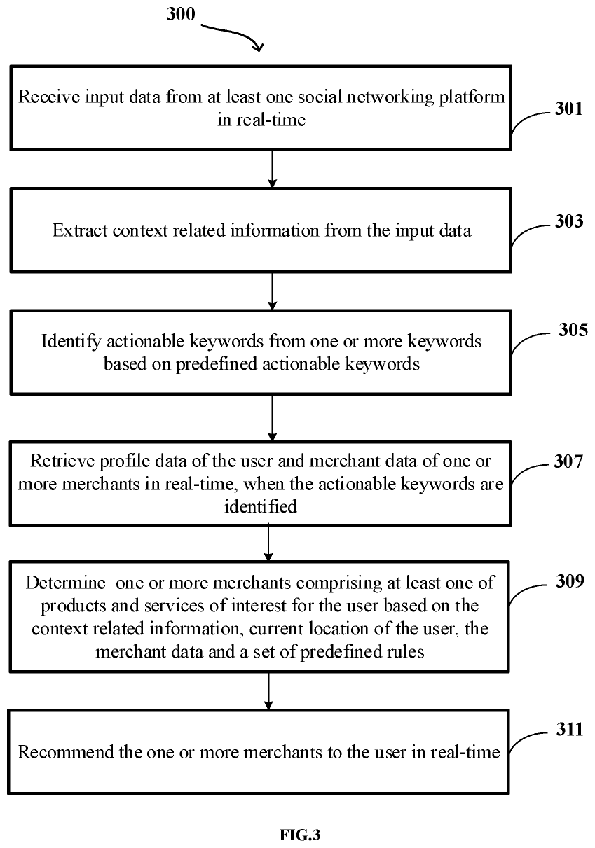

FIG. 3 illustrates a flowchart showing method of providing personalized recommendations in real-time, in accordance with some embodiments of the present disclosure; and

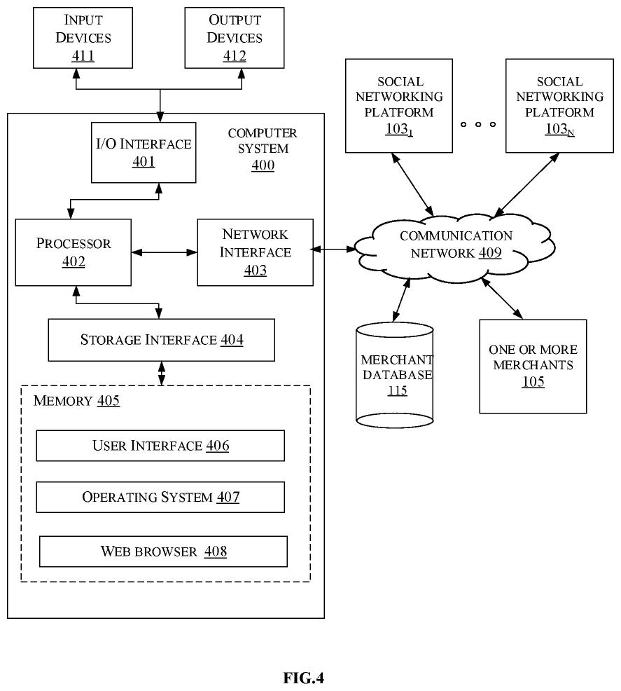

FIG. 4 is a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present disclosure, the word “exemplary” is used herein to mean “serving as an example, instance, or illustration.” Any embodiment or implementation of the present subject matter described herein as “exemplary” is not necessarily to be construed as preferred or advantageous over other embodiments.

While the present disclosure is susceptible to various modifications and alternative forms, specific embodiment thereof has been shown by way of example in the drawings and will be described in detail below. It should be understood, however that it is not intended to limit the present disclosure to the particular forms disclosed, but on the contrary, the present disclosure is to cover all modifications, equivalents, and alternative falling within the scope of the present disclosure.

The terms “comprises,” “comprising,” or any other variations thereof, are intended to cover a non-exclusive inclusion, such that a setup, device, or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

The present disclosure provides a method and a system for providing personalized recommendations in real-time. A recommendation generating system may receive input data from at least one social networking platform in real-time. In some embodiments, the input data may be related to an update by a user on the at least one social networking platform. Upon determining the input data, the recommendation generating system may extract context related information from the input data. In some embodiments, the context related information may include, but is not limited to, one or more keywords and at least one of situation of the user or hashtag related information. Further, the recommendation generating system may identify actionable keywords from the one or more keywords based on predefined actionable keywords. When the actionable keywords are identified, the recommendation generating system may retrieve profile data of the user and merchant data in real-time. In some embodiments, the recommendation generating system may retrieve the profile data from the at least one social networking platform and may retrieve the merchant data from a merchant database associated with the recommendation generating system. Further, based on the context related information, current location of the user, the merchant data and a set of predefined rules, the recommendation generating system may determine one or more merchants including at least one of products or services of interest for the user. Finally, the recommendation generating system may recommend the one or more merchants to the user in real-time.

The present disclosure provides a feature wherein the recommendation generating system may predict the products or services of interest to the user based on the update of the user on social networking platforms, location of the user and profile data of the user. This prediction helps in determining one or more merchants who may be retailing the products and services that are predicted to be of interest to the user, in the location of the user. Therefore, the present disclosure provides personalized recommendations to the user based on situation of the user, thereby improving the user experience. Simultaneously, the present disclosure also improves visibility of the one or more merchants who are situated in low visibility areas such as interior roads, since the one or more merchants are shortlisted based on the prediction of user interests and proximity of the one or more merchants to the location of the user. Further, the present disclosure also enables the user to find one or more merchants who provide the products and services of interest to the user when the user has travelled to new locations.

In the following detailed description of the embodiments of the present disclosure, reference is made to the accompanying drawings that form a part hereof, and in which are shown by way of illustration specific embodiments in which the present disclosure may be practiced. These embodiments are described in sufficient detail to enable those skilled in the art to practice the present disclosure, and it is to be understood that other embodiments may be utilized and that changes may be made without departing from the scope of the present disclosure. The following description is, therefore, not to be taken in a limiting sense.

FIG. 1 shows an exemplary architecture for providing personalized recommendations in real-time in accordance with some embodiments of the present disclosure.

In some embodiments, the architecture 100 may include a user 101, one or more social networking platforms 103₁ to 103ₙ (collectively referred as one or more social networking platforms 103 or at least one social networking platform 103), one or more merchants, 105₁ to 105ₙ (collectively referred as one or more merchants 105), a recommendation generating system 107 and a merchant database 115. In some embodiments, the user 101 may be a member of the one or more social networking platforms 103. The one or more social networking platforms 103 may enable a network of users to perform social interactions. As an example, the one or more social networking platforms 103 may include, but is not limited to, Facebook®, Instagram®, Snapchat®, Pinterest®, LinkedIn®, Twitter®, and the like. In some embodiments, the user 101 may communicate with the one or more social networking platforms 103 via a communication network (not shown in the FIG. 1). As an example, the communication network may be at least one of a wired communication network or a wireless communication network. In some embodiments, the user 101 may access or interact with the one or more social networking platforms 103 via a computing device (not shown in the FIG. 1) such as a laptop, a desktop, a mobile, a Personal Digital Assistant (PDA), a tablet, and the like. Further, the user 101 may have a user profile on the one or more social networking platforms 103 that may include, but is not limited to, profile data of the user 101. As an example, the profile data of the user 101 may include, but is not limited to, interests of the user 101, hobbies of the user 101, age of the user 101, likes and dislikes of the user 101, gender of the user 101, pictures of the user 101, and profession of the user 101.

Further, the user 101 may be associated with the recommendation generating system 107 via the communication network. In some embodiments, the user 101 may initially register with the recommendation generating system 107 to receive one or more personalized recommendations. In some embodiments, post registration, the recommendation generating system 107 may have access to the profile data of the user on the one or more social networking platforms 103.

The one or more merchants 105 may be associated with the recommendation generating system 107 via the communication network. In some embodiments, the one or more merchants 105 may also initially register with the recommendation generating system 107 to enable visibility of the one or more merchants. In some embodiments, post registration, the recommendation generating system 107 may have access to merchant data associated with the one or more merchants 105. As an example, the merchant data may include, but is not limited to, merchant category code, type of products retailed by the merchant 105, offers provided by the merchant 105, location of the merchant 105, and name of the merchant 105. In some embodiments, the recommendation generating system 107 may store the merchant data in the merchant database 115 associated with the recommendation generating system 107 as shown in the FIG. 1. In some embodiments the merchant database 115 may be configured in the recommendation generating system 107.

The recommendation generating system 107 may include a processor 109, an input/output (I/O) interface 111 and a memory 113. The I/O interface 111 may receive input data from the at least one social networking platform 103, in real-time. As an example, the input data may be related to an update by the user 101 on the at least one social networking platform 103. As an example, the update may be a status update, a check-in update, an image update, and the like. Further, the processor 109 may extract context related information from the input data. In some embodiments, the context related information may include, but is not limited to, one or more keywords and at least one of a situation of the user or hashtag related information. Further, the processor 109 may identify actionable keywords from the one or more keywords based on predefined actionable keywords. In some embodiments, the processor 109 may classify the one or more keywords into a predefined category among plurality of predefined categories prior to identification of the actionable keywords. As an example, the plurality of predefined categories may include fashion, food, electronic gadgets, gifts, books and the like. When the actionable keywords are identified, the processor 109 may retrieve the profile data of the user 101 and the merchant data in real-time. In some embodiments, the processor 109 may retrieve the profile data from the at least one social networking platform 103. In some other embodiments, the profile data of the user 101 may be stored in the memory 113, which may be periodically updated by the processor 109. In some embodiments, the processor 109 may retrieve the merchant data from the merchant database 115. Further, the processor 109 may determine one or more merchants 105 including at least one of products or services of interest for the user 101 based on the context related information, current location of the user 101, the merchant data, and a set of predefined rules. In some embodiments, the processor 109 may receive the current location of the user 101 via a global positioning system (GPS) module configured in the computing device of the user 101. In some embodiments, the set of predefined rules may allow the processor 109 to map the user 101 with the one or more merchants 105. Finally, the processor 109 may recommend the one or more merchants 105 to the user in real-time. In some embodiments, the recommendation may be a personalized recommendation based on the situation of the user 101 and the interests of the user 101.

FIG. 2A shows a detailed block diagram of a recommendation generating system for providing personalized recommendations in real-time in accordance with some embodiments of the present disclosure.

In some implementations, the recommendation generating system 107 may include data 203 and modules 205. As an example, the data 203 is stored in a memory 113 configured in the recommendation generating system 107 as shown in the FIG. 2A. In one embodiment, the data 203 may include input data 207, context related information 209, actionable keywords data 211, recommendation data 213, and other data 215. In the embodiment illustrated FIG. 2A, modules 205 are described in detail.

In some embodiments, the data 203 may be stored in the memory 113 in form of various data structures. Additionally, the data 203 can be organized using data models, such as relational or hierarchical data models. The other data 215 may store data, including temporary data and temporary files, generated by the modules 205 for performing the various functions of the recommendation generating system 107.

In an embodiment, the data 203 stored in the memory 113 may be processed by the modules 205 of the recommendation generating system 107. The modules 205 may be stored within the memory 113. In an example, the modules 205, communicatively coupled to a processor 109 configured in the memory management system 107, may also be present outside the memory 113 as shown in FIG. 2A and implemented as hardware. As used herein, the term module refers to an application specific integrated circuit (ASIC), an electronic circuit, a processor (shared, dedicated, or group) and memory that execute one or more software or firmware programs, a combinational logic circuit, and/or other suitable components that provide the described functionality.

In an embodiment, the modules 205 may include, for example, a receiving module 221, a context extracting module 223, a keyword identifying module 225, a retrieving module 227, a merchant determining module 229, a recommendation module 231 and other modules 233. The other modules 233 may be used to perform various miscellaneous functionalities of the recommendation generating system 107. It will be appreciated that such modules 205 may be represented as a single module or a combination of different modules.

In some embodiments, the receiving module 221 may receive the input data 207 from at least one social networking platform 103 in real-time. As an example, the input data 207 may be related to an update by a user 101 on the at least one social networking platform 103. As an example, the update may be a status update, a check-in update, an image update, and the like. Consider an exemplary scenario, where the user 101 is travelling to Rome. The user 101 may update the status as “Off to Rome # vacation.” Consider an exemplary scenario where the user 101 is in Delhi. The user 101 may update the status as “Looking forward to have authentic Delhi food” or “Shopping in Delhi” and the like.

In some embodiments, the context extracting module 223 may extract context related information 209 from the input data 207. In some embodiments, the context related information 209 may include, but is not limited to, one or more keywords and at least one of situation of the user 101 or hashtag related information. In some embodiments, the context extracting module 223 may parse and process each word, phrase, symbols and the like present in the input data 207 using one or more predefined natural language processing (NLP) techniques to extract the context related information 209. In some embodiments, the context extracting module 223 may also extract location of the user 101 from the input data 207. In some other embodiments, the context extracting module 223 may extract the location of the user 101 from a GPS module configured in computing device associated with the user 101. In some embodiments, the user 101 may have posted the update on the at least one social network platform 103 using the computing device.

Consider an exemplary scenario where the user 101 has updated the status as “Flight delayed by 3 hours. # FeelingBored # hungry.” From the status, the context extracting module 223 may extract the following:
Keywords: Flight, delay, bored, hungry
Hashtags: # FeelingBored, # hungry

In the above scenario, if the user 101 has updated the status as “Flight delayed by 3 hours. Stuck in Mumbai airport. # FeelingBored # hungry.” In such cases, the context extracting module 223 may also extract location of the user 101 from the status, for example in this case, location is “Mumbai airport.” Further, the context extracting module 223 may extract the precise location of the user 101 based on GPS co-ordinates received from the computing device of the user 101.

In some embodiments, when the input data 207 is received from more than one social networking platform 103, the context extracting module 223 may combine and correlate the update of the user 101, time of the update, location of the user 101 when the update was posted, and the like, received from each of the one or more social networking platforms 103 to exactly understand context of the input data 207.

As an example, consider a scenario where the user 101 has updated the status as “Flight delayed by 3 hours” in one social network platform. In another social network platform, consider the user 101 updated the status as “Feeling hungry in Mumbai airport.” Therefore, from the update on one social network platform, the context extracting module 223 may understand that user 101 has 3 hours to spend in the airport. Parallelly, from the update on another social networking platform, the context extracting module 223 may understand that the user 101 is in Mumbai airport and is also feeling hungry.

Further, in some embodiments, the keyword identifying module 225 may identify actionable keywords from the one or more keywords based on predefined actionable keywords. In some embodiments, the actionable keywords may be the keywords that may trigger an action. To identify the actionable keywords, the keyword identifying module 225 may initially create a first set of keywords including the one or more keywords and synonyms of the one or more keywords. Further, the keyword identifying module 225 may classify the each of the first set of keywords into a predefined category among plurality of predefined categories. As an example, the plurality of predefined categories may include fashion, food, electronic gadgets, gifts, books, and the like. Further, the keyword identifying module 225 may compare each of the first set of keywords with the predefined actionable keywords of the corresponding predefined category using NLP techniques.

Based on the comparison, the keyword identifying module 225 may determine a relevancy score for each of the first set of keywords using one or more predefined techniques. Further, the keyword identifying module 225 may compare the relevancy score of each of the first set of keywords with a predefined threshold to identify each of the first set of keywords having the relevancy score greater than or equal to the predefined threshold. As an example, the predefined threshold may be configured in a range of 75%-95%. In some embodiments, when the relevancy score is greater than the predefined threshold, the keyword identifying module 225 infers that the keyword matches with the predefined actionable keyword. Therefore, each of the first set of keywords having the relevancy score greater than or equal to the predefined threshold may be identified as the actionable keywords from the first set of keywords. The actionable keywords thus identified may be stored as the actionable keywords data 211. FIG. 2B is a pictorial representation of exemplary predefined categories and corresponding exemplary actionable keywords. As shown in the FIG. 2B, the exemplary predefined categories are indicated using circles and the corresponding actionable keywords are indicated using rectangular boxes. Further, in some embodiments, the keyword identifying module 225 may identify the synonyms of the one or more keywords that determined as the actionable keywords (i.e. the synonyms of the one or more keywords whose relevancy score is greater than or equal to the predefined threshold). If the identified synonyms are new and not part of the predefined actionable keywords, the processor 109 may update the synonyms of the one or more keywords to the predefined actionable keywords in real-time.

In some embodiments, upon determining the actionable keywords, the retrieving module 227 may retrieve profile data of the user 101 in real-time. As an example, the profile data of the user 101 may include, but is not limited to, interests of the user 101, hobbies of the user 101, age of the user 101, likes and dislikes of the user 101, gender of the user 101, pictures of the user 101, and profession of the user 101. In some embodiments, the processor 109 may retrieve the profile data from the at least one social networking platform 103. In some other embodiments, the profile data of the user 101 may be stored in the memory 113, which may be periodically updated by the processor 109.

Further, the retrieving module 227 may simultaneously retrieve merchant data of one or more merchants 105 in real-time. In some embodiments, the retrieving module 227 may retrieve the merchant data from a merchant database 115 associated with the recommendation generating system 107. As an example, the merchant data may include, but is not limited to, merchant category code, type of products retailed by the merchant 105, offers provided by the merchant 105, location of the merchant 105, and name of the merchant 105.

In some embodiments, upon retrieving the profile data and the merchant data, the merchant determining module 229 may determine one or more merchants 105 including at least one of products or services of interest for the user 101. To determine the one or more merchants 105, the merchant determining module 229 may initially determine a first set of merchants 105 including products and services of interest for the user 101 based on the context related information, the current location of the user 101, the merchant data, and the set of predefined rules. Further, the merchant determining module 229 may determine the one or more merchants 105 relevant to the user 101 from the first set of merchants 105 based on the profile data of the user 101.

As an example, consider an exemplary scenario where the user 101 has updated the status as

“Flight delayed by 3 hours. # FeelingBored # hungry.”
In this scenario, the context related information 209 may be
Actionable keywords: Flight, delay, bored, hungry
Hashtags: # FeelingBored, # hungry
Situation: Stuck in airport for 3 hours
Current location of the user 101: (X, Y)

Therefore, based on the current location of the user 101 and the context related information 209, the merchant determining module 229 may filter the merchants 105 to determine the first set of merchants 105.

As an example, since the user 101 is stuck in the airport, the merchant determining module 229 may filter the merchants 105 who are outside the perimeter of the airport. Therefore, the first set of merchants 105 may include only the merchants 105 who are situated inside the airport. In one embodiment, the merchant determining module 229 may consider to draw a boundary around the GPS location received from the user 101. For example, 300 meters around the GPS location. In one embodiment this boundary may be extended until the merchant determining module 229 finds a predefined number of merchants for further processing.

Further, based on the above mentioned actionable keywords, the merchant determining module 229 may determine the plurality of predefined categories corresponding to the actionable keywords. In this scenario, since the actionable keywords are Flight, delay, bored and hungry, as per the FIG. 2B, the predefined categories corresponding to the actionable keywords may be restaurants/food outlets, shopping, and reading. Therefore, the merchant determining module 229 may further filter the first set of merchants 105 such that, the first set of merchants 105 include the merchants 105 who deal with products and services related to restaurants/food outlets, shopping, and reading. Therefore, consider the first set of merchants 105 includes the following:
Merchant 1—Chinese restaurant “ABC”
Merchant 2—Italian restaurant “PQR”
Merchant 3—Pure vegetarian restaurant “EFG”
Merchant 4—Clothing store “DEF”
Merchant 5—Book store “ABCD”

Further, the merchant determining module 229 may determine the one or more merchants 105 relevant to the user 101 based on the profile data of the user 101. As an example, consider the profile data of the user 101 includes hobbies and likes of the user 101 as shown below:
Hobbies: Reading books, badminton
Likes:
Movies: Fiction, Romantic
Food: Chinese, Mughlai
Sports: Cricket, football
Actor: John

In some embodiments, the merchant determining module 229 may map merchant category or the products and services of the first set of merchants 105 with the profile data of the user 101. Based on the mapping, the merchant determining module 229 may determine that products of Merchant 1 match with the likes of the user 101. Further, products of the Merchant 5 match with the hobbies and likes of the user 101.

Therefore, the merchant determining module 229 may determine Merchant 1 and Merchant 5 as the relevant merchants 105 for the user 101 from the first set of merchants 105. In some embodiments, the set of predefined rules may specify certain limitations for the merchant determining module 229 for determining the one or more merchants 105.

As an example, exemplary set of predefined rules may be as shown below:
Proximity range of the merchants 105 to the location of the user: radius of 2 kilometres (kms)
Minimum relevancy of merchant products and services to the profile data of the user 101: 70%
Maximum number of merchants 105 to be determined: 5

In some embodiments, the recommendation module 231 may recommend the one or more merchants 105 to the user 101 in real-time. Considering the above example, the recommendation module 231 may recommend Merchant 1 and Merchant 5 to the user 101. Since, the recommendations provided to the user 101 are based on the context related information, location and profile data of the user 101, the recommendations may be referred as personalized recommendations for the user 101. In a scenario where a second user is in the same situation as the user 101, the recommendations provided to the second user may be different from the recommendations provided to the user 101, since the recommendations would be specific to the context related information and the profile data of the second user. FIG. 2C shows an exemplary recommendation provided to the user 101.

In some embodiments, the recommendation may be provided to the computing device of the user 101. As an example, the recommendation may be in the form of a text message, a notification, a flash message, and the like. In some embodiments, the computing device of the user 101 may be installed with an application related to the recommendation generating system 107. In some embodiments, the recommending module 231 may provide the recommendations to the user 101 through the application installed in the computing device of the user 101. In some embodiments, the recommendations provided to the user 101 may be stored as the recommendation data 213.

Further, in some embodiments, the merchant determining module 229 may consider to draw a boundary around the GPS location received from the user 101. For example, 300 meters around the GPS location to find merchants. In one embodiment this boundary may be extended until the merchant determining module 229 finds a recommendation for the user 101. In another embodiment, the boundary may be extended until the merchant determining module 229 finds a predefined number of recommendations for the user 101.

FIG. 3 illustrates a flowchart showing a method of providing personalized recommendations in real-time, in accordance with some embodiments of the present disclosure.

As illustrated in FIG. 3, the method 300 comprises one or more blocks illustrating method of managing system data for optimizing boot time of a system. The method 300 may be described in the general context of computer executable instructions. Generally, computer executable instructions can include routines, programs, objects, components, data structures, procedures, modules, and functions, which perform particular functions or implement particular abstract data types.

The order in which the method 300 is described is not intended to be construed as a limitation, and any number of the described method blocks can be combined in any order to implement the method 300. Additionally, individual blocks may be deleted from the method 300 without departing from the spirit and scope of the subject matter described herein. Furthermore, the method 300 can be implemented in any suitable hardware, software, firmware, or combination thereof.

At block 301, the method 300 may include receiving, by a processor 109 of the recommendation generating system 107, input data 207 from at least one social networking platform 103 in real-time. The input data 207 may be related to an update by a user 101 on the at least one social networking platform 103. As an example, the update may be a status update, a check-in update, an image update, and the like.

At block 303, the method 300 may include extracting, by the processor 109, context related information from the input data 207. In some embodiments, the context related information 209 may include, but is not limited to, one or more keywords and at least one of situation of the user 101 or hashtag related information.

At block 305, the method 300 may include identifying, by the processor 109, actionable keywords from the one or more keywords based on predefined actionable keywords. In some embodiments, the processor 109 may classify the one or more keywords into a predefined category among plurality of predefined categories prior to identification of the actionable keywords.

At block 307, the method 300 may include retrieving, by the processor 109, profile data of the user 101 and merchant data of one or more merchants 105 in real-time, when the actionable keywords are identified. In some embodiments, the processor 109 may retrieve the profile data from the at least one social networking platform 103 and the merchant data from a merchant database 115 associated with the recommendation generating system 107.

At block 309, the method 300 may include determining, by the processor 109, one or more merchants 105 comprising at least one of products or services of interest for the user 101 based on the context related information, current location of the user 101, the merchant data and a set of predefined rules. In some embodiments, the processor 109 ensures determining relevant merchants 105 for the user 101 by using the profile data of the user 101.

At block 307, the method 300 may include recommending, by the processor 109, the one or more merchants 105 to the user 101 in real-time.

FIG. 4 is a block diagram of an exemplary computer system for implementing embodiments consistent with the present disclosure.

In an embodiment, FIG. 4 illustrates a block diagram of an exemplary computer system 400 for implementing embodiments consistent with the present disclosure. In an embodiment, the computer system 400 can be recommendation generating system 107 that is used for providing personalized recommendations in real-time. The computer system 400 may include a central processing unit (“CPU” or “processor”) 402. The processor 402 may include at least one data processor for executing program components for executing user or system-generated business processes. A user may include a person, a person using a device such as such as those included in this invention, or such a device itself. The processor 402 may include specialized processing units such as integrated system (bus) controllers, memory management control units, floating point units, graphics processing units, digital signal processing units, etc.

The processor 402 may be disposed in communication with one or more I/O devices (411 and 412) via I/O interface 401. The I/O interface 401 may employ communication protocols/methods such as, without limitation, audio, analog, digital, stereo, IEEE-1394, serial bus, universal serial bus (USB), infrared, PS/2, BNC, coaxial, component, composite, digital visual interface (DVI), high-definition multimedia interface (HDMI), radio frequency (RF) antennas, S-Video, video graphics array (VGA), IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 401, computer system 400 may communicate with one or more I/O devices (411 and 412).

In some embodiments, the processor 402 may be disposed in communication with a communication network 409 via a network interface 403. The network interface 403 may communicate with the communication network 409. The network interface 403 may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. Using the network interface 403 and the communication network 409, the computer system 400 may communicate with one or more social networking platforms 103, a merchant database 115 and a computing device of the user 101 (not shown in the FIG. 4). The communication network 409 can be implemented as one of the different types of networks, such as intranet or local area network (LAN) and such within the organization. The communication network 409 may either be a dedicated network or a shared network, which represents an association of the different types of networks that use a variety of protocols, for example, hypertext transfer protocol (HTTP), TCP/IP, wireless application protocol (WAP), etc., to communicate with each other. Further, the communication network 409 may include a variety of network devices, including routers, bridges, servers, computing devices, storage devices, etc. In some embodiments, the processor 402 may be disposed in communication with a memory 405 (e.g., RAM, ROM, etc. not shown in FIG. 4) via a storage interface 404. The storage interface 404 may connect to memory 405 including, without limitation, memory drives, removable disc drives, etc., employing connection protocols such as serial advanced technology attachment (SATA), integrated drive electronics (IDE), IEEE-1394, USB, fibre channel, small computer systems interface (SCSI), etc. The memory drives may further include a drum, magnetic disc drive, magneto-optical drive, optical drive, Redundant Array of Independent Discs (RAID), solid-state memory devices, solid-state drives, etc.

The memory 405 may store a collection of program or database components, including, without limitation, a user interface 406, an operating system 407, a web browser 408, etc. In some embodiments, the computer system 400 may store user/application data, such as the data, variables, records, etc. as described in the present disclosure. Such databases may be implemented as fault-tolerant, relational, scalable, secure databases such as Oracle or Sybase. The operating system 407 may facilitate resource management and operation of the computer system 400. Examples of operating systems include, without limitation, Apple Macintosh OS X, UNIX, Unix-like system distributions (e.g., Berkeley software distribution (BSD), FreeBSD, NetBSD, OpenBSD, etc.), Linux distributions (e.g., Red Hat, Ubuntu, Kubuntu, etc.), International Business Machines (IBM) OS/2, Microsoft Windows (XP, Vista/7/8, etc.), Apple iOS, Google Android, Blackberry Operating System (OS), or the like. The User interface 406 may facilitate display, execution, interaction, manipulation, or operation of program components through textual or graphical facilities. For example, user interfaces may provide computer interaction interface elements on a display system operatively connected to the computer system 400, such as cursors, icons, check boxes, menus, scrollers, windows, widgets, etc. Graphical User Interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like.

In some embodiments, the computer system 400 may implement the web browser 408 stored program components. The web browser 408 may be a hypertext viewing application, such as Microsoft Internet Explorer, Google Chrome, Mozilla Firefox, Apple Safari, etc. Secure web browsing may be provided using secure hypertext transport protocol (HTTPS), secure sockets layer (SSL), transport layer security (TLS), etc. Web browsers may utilize facilities such as AJAX, DHTML, Adobe Flash, JavaScript, Java, application programming interfaces (APIs), etc. In some embodiments, the computer system 400 may implement a mail server stored program component. The mail server may be an Internet mail server such as Microsoft Exchange, or the like. The mail server may utilize facilities such as active server pages (ASP), ActiveX, American National Standards Institute (ANSI) C++/C #, Microsoft .NET, CGI scripts, Java, JavaScript, PERL, PHP, Python, WebObjects, etc. The mail server may utilize communication protocols such as Internet message access protocol (IMAP), messaging application programming interface (MAPI), Microsoft Exchange, post office protocol (POP), simple mail transfer protocol (SMTP), or the like. In some embodiments, the computer system 400 may implement a mail client stored program component. The mail client may be a mail viewing application, such as Apple Mail, Microsoft Entourage, Microsoft Outlook, Mozilla Thunderbird, etc.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., non-transitory. Examples include random access memory (RAM), read-only memory (ROM), volatile memory, non-volatile memory, hard drives, compact disc (CD) ROMs, digital video disc (DVDs), flash drives, disks, and any other known physical storage media.

### Advantages of the Embodiment of the Present Disclosure are Illustrated Herein

In an embodiment, the present disclosure provides a method and a system for providing personalized recommendations in real-time.

The present disclosure provides a feature wherein the recommendation generating system may predict the products or services of interest to the user based on the update of the user on social networking platforms, location of the user and profile data of the user. This prediction helps in determining one or more merchants who may be retailing the products and services that are predicted to be of interest to the user, in the location of the user. Therefore, the present disclosure provides personalized recommendations to the user based on situation of the user, thereby improving the user experience.

Further, the present disclosure also improves visibility of the one or more merchants who are situated in low visibility areas such as interior roads, since the one or more merchants are shortlisted based on the prediction of user interests and proximity of the one or more merchants to the location of the user.

Further, the present disclosure also enables the user to find one or more merchants who provide the products and services of interest to the user when the user has travelled to new locations.

A description of an embodiment with several components in communication with each other does not imply that all such components are required. On the contrary a variety of optional components are described to illustrate the wide variety of possible embodiments of the invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The specification has described a method and a system for providing personalized recommendations in real-time. The illustrated steps are set out to explain the exemplary embodiments shown, and it should be anticipated that on-going technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present disclosure are intended to be illustrative, but is not limiting, of the scope of the invention, which is set forth in the following claims.

### REFERENCE NUMERALS

| Reference Number | Description |
|---|---|
| 100 | Architecture |
| 101 | User |
| 103 | Social networking platform |
| 105 | One or more merchants |
| 107 | Memory management system |
| 109 | Processor |
| 111 | I/O interface |
| 113 | Memory |
| 115 | Merchant database |
| 203 | Data |
| 205 | Modules |
| 207 | Input data |
| 209 | Context related information |
| 211 | Actionable keywords data |
| 213 | Recommendation data |
| 215 | Other data |
| 221 | Receiving module |
| 223 | Context extracting module |
| 225 | Keyword identifying module |
| 227 | Retrieving module |
| 229 | Merchant determining module |
| 231 | Recommendation module |
| 233 | Other modules |
| 400 | Exemplary computer system |
| 401 | I/O Interface of the exemplary computer system |
| 402 | Processor of the exemplary computer system |
| 403 | Network interface |
| 404 | Storage interface |
| 405 | Memory of the exemplary computer system |
| 406 | User interface |
| 407 | Operating system |
| 408 | Web browser |
| 409 | Communication network |
| 411 | Input devices |
| 412 | Output devices |

What is claimed is:

1. A method of providing personalized recommendations in real-time, the method comprising:
receiving, by a recommendation generating system, input data from at least one social networking platform in real-time, wherein input data is related to an update posted by a user on the at least one social networking platform;
extracting, by the recommendation generating system, context related information from the input data, wherein the context related information comprises one or more keywords and at least one of a situation of the user or hashtag related information;
identifying, by the recommendation generating system, an actionable keyword from the one or more keywords based on a comparison with a predefined actionable keyword;
retrieving, by the recommendation generating system, profile data of the user and merchant data of one or more merchants in real-time, in response to identifying the actionable keyword, wherein the profile data is retrieved from the at least one social networking platform and the merchant data is retrieved from a merchant database associated with the recommendation generating system;
determining, by the recommendation generating system, one or more target merchants associated with at least one of products or services of interest for the user based on the context related information, a current location of the user, the merchant data, and a set of predefined rules; and
recommending, by the recommendation generating system, the one or more target merchants to the user in real-time.

2. The method of claim 1, wherein determining the one or more target merchants comprises:
determining, by the recommendation generating system, a first set of merchants associated with at least one of products or services of interest for the user based on the context related information, the current location of the user, the merchant data, and the set of predefined rules; and
determining, by the recommendation generating system, relevance of each merchant in the first set of merchants based on the profile data.

3. The method of claim 1, wherein the profile data comprises at least one of an interest of the user, a hobby of the user, an age of the user, a like of the user, a dislike of the user, a gender of the user, or a profession of the user.

4. The method of claim 1, wherein the merchant data comprises at least one of merchant category code, type of products retailed by a merchant, offers provided by the merchant, location of the merchant, or name of the merchant.

5. The method of claim 1, wherein identifying the actionable keyword from the one or more keywords comprises:
classifying, by the recommendation generating system, a first set of keywords into a predefined category among a plurality of predefined categories, wherein the first set of keywords comprises at least one of, the one or more keywords or synonyms of the one or more keywords;
comparing, by the recommendation generating system, each of the keywords in the first set of keywords with the predefined actionable keyword corresponding to the predefined category using Natural Language Processing techniques;
determining, by the recommendation generating system, a relevancy score for each of the keywords in the first set of keywords based on the comparison;
comparing each of the relevancy scores to a predefined threshold;
determining that one of the keywords in the first set of keywords is one of the actionable keyword in response to determining that the relevancy score for the one of the keywords in the first set of keywords is greater than or equal to the predefined threshold.

6. The method of claim 5 further comprising updating, by the recommendation generating system, the synonyms of the one or more keywords to the predefined actionable keyword in real-time, when the corresponding relevancy score is greater than or equal to the predefined threshold.

7. A recommendation generating system for providing personalized recommendations in real-time, the recommendation generating system comprising:
a processor; and
a memory communicatively coupled to the processor, wherein the memory stores processor-executable instructions, which, on execution, causes the processor to:
receive input data from at least one social networking platform in real-time, wherein the input data is related to an update posted by a user on the at least one social networking platform;
extract context related information from the input data, wherein the context related information comprises one or more keywords and at least one of a situation of the user or hashtag related information;
identify an actionable keyword from the one or more keywords based on predefined actionable keyword;
retrieve, in response to identifying the actionable keyword, profile data of the user and merchant data in real-time, wherein the profile data is retrieved from the at least one social networking platform and the merchant data is retrieved from a merchant database associated with the recommendation generating system;
determine one or more target merchants associated with at least one of products or services of interest for the user based on the context related information, a current location of the user, the merchant data, and a set of predefined rules; and
recommend the one or more target merchants to the user in real-time.

8. The recommendation generating system of claim 7, wherein the processor determines the one or more target merchants by:
determining a first set of merchants associated with at least one of products or services of interest for the user based on the context related information, the current location of the user, the merchant data, and the set of predefined rules; and
determining relevance of each merchant in the first set of merchants based on the profile data.

9. The recommendation generating system of claim 7, wherein the profile data comprises at least one of an interest of the user, a hobby of the user, an age of the user, a like of the user, a dislike of the user, a gender of the user, or a profession of the user.

10. The recommendation generating system of claim 7, wherein the merchant data for each merchant in the first set of merchant comprises at least one of a merchant category code associated with the merchant, a type of product the merchant, an offer provided by the merchant, a location of the merchant, or a name of the merchant.

11. The recommendation generating system of claim 7, wherein the processor identifies the actionable keyword from the one or more keywords by:
classifying a first set of keywords into a predefined category among a plurality of predefined categories, wherein the first set of keywords comprises at least one of, the one or more keywords or synonyms of the one or more keywords;
comparing each of the keywords in the first set of keywords with the predefined actionable keyword corresponding to the predefined category using Natural Language Processing techniques;
determining a relevancy score for each of the keywords in the first set of keywords based on the comparison;
comparing each of the relevancy scores to a predefined threshold;
determining that one of the keywords in the first set of keywords is one of the actionable keyword in response to determining that the relevancy score for the one of the keywords in the first set of keywords is greater than or equal to the predefined threshold.

12. The recommendation generating system of claim 11, wherein the processor is further configured to update the synonyms of the one or more keywords to the predefined actionable keyword in real-time, when the corresponding relevancy score is greater than or equal to the predefined threshold.

13. A non-transitory computer readable medium including instructions stored thereon that when processed by at least one processor causes a recommendation generating system to:
receive input data from at least one social networking platform in real-time, wherein the input data is related to an update posted by a user on the at least one social networking platform;
extract context related information from the input data, wherein the context related information comprises one or more keywords and at least one of a situation of the user or hashtag related information;
identify an actionable keyword from the one or more keywords based on a predefined actionable keyword;
retrieve, in response to identifying the actionable keyword, profile data of the user and merchant data of one or more merchants in real-time, when the actionable keyword is identified, wherein the profile data is retrieved from the at least one social networking platform and the merchant data is retrieved from a merchant database associated with the recommendation generating system;
determine one or more target merchants associated with at least one of products or services of interest for the user based on the context related information, a current location of the user, the merchant data, and a set of predefined rules; and
recommend the one or more target merchants to the user in real-time.

14. The non-transitory computer readable medium of claim 13, wherein the profile data comprises at least one of an interest of the user, a hobby of the user, an age of the user, a like of the user, a dislike of the user, a gender of the user, or a profession of the user.

15. The non-transitory computer readable medium of claim 13, wherein the merchant data comprises at least one of a merchant category code associated with the one or more merchants, a type of product the one or more merchants, an offer provided by the one or more merchants, a location of the one or more merchants, or a name of the one or more merchants.
